(19) United States
(12) Patent Application Publication
(10) Pub. No.: US 2026/0011740 A1
(43) Pub. Date: Jan. 8, 2026

(54) ANODE COMPOSITION CONTAINING AN ORGANOSULFUR BINDER

(71) Applicant: COATEX, Genay (FR)

(72) Inventors: Guillaume MICHAUD, Lyon (FR); Jean-Marc SUAU, Lucenay (FR)

(73) Assignee: COATEX, Genay (FR)

(21) Appl. No.: 18/992,338

(22) PCT Filed: Jul. 10, 2023
(86) PCT No.: PCT/FR2023/000131

§ 371 Date: Jan. 8, 2025

(30) Foreign Application Priority Data
Aug. 3, 2022 (FR) FR2208066

(51) Int. Cl. H01M 4/62; H01M 4/02; H01M 4/04; H01M 4/38; H01M 4/583

(52) U.S. Cl. CPC H01M 4/623; H01M 4/0404; H01M 4/0435; H01M 4/382; H01M 4/386; H01M 4/583; H01M 2004/021; H01M 2004/027

(57) ABSTRACT

An aqueous anode composition of metal particles or fibres or carbon graphite particles or fibres, and a binding agent. The binding agent includes at least one water-soluble polymer P prepared on the basis of an organosulfur monomer. A method for making the aqueous anode composition and a method for producing an anode using the aqueous composition is also described.

The invention relates to an aqueous anode composition comprising metal or carbon graphite particles or fibres and a binding agent comprising at least one water-soluble polymer P that is prepared using an organosulphur monomer. The invention also relates to a method for producing an anode using said aqueous composition.

There are known anode compositions that generally comprise carbon or a metal in the form of particles associated with a binding composition. This binding composition must be able to effectively bind the carbon or the metal to a substrate to form an anode. The most common binding compositions comprise a styrene-butadiene polymer. The composition makes it possible to fix the particles on a metal substrate. The binding property is therefore decisive when producing an anode using these anode compositions. In addition, mechanical strength or electrochemical resistance is particularly sought.

Easy, uniform application of anode compositions is necessary in order to obtain a uniform layer and to limit or avoid flaws on the surface of the anode, resulting in a uniform and particularly effective conductive layer.

Generally, binding compositions also comprise various additives such as thickening agents, dispersing agents, for example a cellulose derivative. The most common cellulose derivatives are carboxymethylcellulose, hydroxyethyl cellulose and hydroxy methylcellulose.

These anode compositions frequently comprise silicon in order to increase the capacity of the prepared anodes. During the charging-discharging cycles of the batteries containing these anodes, it is usual to observe a strain that can lead to irreversible alteration of the anode, particularly as a result of the increase in the volume of the silicon. Strain tolerance is therefore also a desirable property.

It should be possible to reduce the number of ingredients used when preparing anode compositions.

The compatibility of the different ingredients of the anode compositions is also an important factor when preparing anode compositions as well as when preparing anodes using these compositions.

Document EP 3214676 discloses a pulp for preparing a secondary lithium-ion battery anode that comprises a water-soluble polyacrylic copolymer. Document WO 2014024937 describes a secondary battery anode prepared using a binder and a fluorinated, sulphonated polymer. Document WO 2015008626 describes a poly(meth)acrylamide binding agent for battery preparation, with a weight-average molecular mass ranging from 300,000 to 6,000,000 g/mol. Document KR 20210064944 describes a copolymer made of PVDF and of styrene sulphonic acid.

The anode compositions in the prior art are not always satisfactory. There is thus a need for anode compositions that provide solutions to all or part of the problems of the anode compositions in the prior art.

The invention therefore provides an aqueous anode composition T comprising:
from 0.5% to 15% by dry weight of at least one binding agent L comprising at least one water-soluble polymer P, with a weight-average molecular mass Mw (measured by SEC) ranging from 2,000 g/mol to 1,000,000 g/mol, prepared in the presence of at least one initiator compound, by a polymerisation reaction of at least one organosulphur monomer M and
from 85% to 99.5% by dry weight of at least one material E chosen among metal fibres, metal particles, carbon graphite fibres, carbon graphite particles, silicon particles and combinations thereof,
   relative to the total amount by dry weight of binding agent L and of material E.

Essentially for the invention, the polymer P is prepared using the monomer M, which is an organosulphur compound. The monomer M comprises non-mineral sulphur combined with at least one organic residue, preferably combined with a hydrocarbon residue which can comprise one or more heteroatoms such as oxygen or nitrogen or even phosphorus. Preferably according to the invention, the monomer M is chosen among a sulphonated monomer M1, a sulphated monomer M2, and combinations thereof. According to the invention, the sulphonated monomer M1 comprises at least one sulphonate ion or group of formula SO₃⁻ and the sulphated monomer M2 comprises at least one sulphate ion or group of formula SO₄⁻. More preferably according to the invention, the monomer M is a sulphonated monomer M1.

According to the invention, the monomer M also comprises at least one polymerisable group, preferably at least one ethylenic unsaturation group, in particular a methacrylate group, an acrylate group, a methacrylamide group, an acrylamide group, a styrene group, an allyl group, a methallyl group, an isoprenyl group or a vinyl group.

Particularly preferably according to the invention, the organosulphur monomer M is chosen among 2-acrylamido-2-methylpropane sulphonic acid (AMPS), allyl sulphonic acid, alkylenesulphonates, alkylenearylsulphonates, in particular styrene sulphonate, vinyl sulphonate, methallyl sulphonate, allyl sulphonate, methallyl sulphate, allyl sulphate, 2-sulphoethyl methacrylate, 3-allyloxy-2-hydroxy-1-propanesulphonic acid, 3-sulphopropyl methacrylate, their salts and combinations thereof. The preferred monomers M are sodium salt of 2-acrylamido-2-methylpropanesulphonic acid (AMPS), sodium salt of 3-allyloxy-2-hydroxy-1-propanesulphonic acid and sodium styrene sulphonate, particularly sodium salt of 2-acrylamido-2-methylpropane sulphonic acid (AMPS).

Advantageously according to the invention, only the monomer M can be used when preparing the polymer P. Preferably according to the invention, the monomer M can be combined with at least one other monomer, preferably with at least one other monomer chosen among an anionic monomer, a non-ionic monomer and combinations thereof. Also more preferentially, the monomer M can be combined with at least one other anionic monomer.

Preferably according to the invention, the monomer M can be combined with at least one other anionic monomer M3 chosen among acrylic acid, methacrylic acid, an acrylic acid salt, a methacrylic acid salt, maleic acid, a maleic acid salt, itaconic acid, an itaconic acid salt, crotonic acid, a crotonic acid salt, an acrylic acid oligomer and combinations thereof. More preferentially according to the invention, the monomer M can be combined with at least one other anionic monomer M3 chosen among acrylic acid, methacrylic acid, an acrylic acid salt, a methacrylic acid salt and combinations thereof. Preferably according to the invention, the monomer M3 is used in an amount of from 2% by weight to 98% by weight, preferably from 5% by weight to 90% by weight or from 15% by weight to 85% by weight relative to the total amount by weight of monomers.

Also preferably according to the invention, the monomer M can be combined with at least one other non-ionic monomer M4 chosen among vinyl acetate, a C₁-C₈ ester from a compound derived from an acid chosen among acrylic acid, methacrylic acid, maleic acid, itaconic acid and crotonic acid, (ethyl methacrylate, methyl methacrylate, butyl methacrylate, ethyl acrylate, methyl acrylate, butyl acrylate), hydroxyethylmethacrylate, hydroxyethylacrylate, hydroxypropylmethacrylate, hydroxypropylacrylate, an amino monomer (acrylonitrile, vinyl lactam), styrene and combinations thereof. More preferentially according to the invention, the monomer M can be combined with at least one other non-ionic monomer M4 chosen among vinyl acetate, a C₁-C₈ ester from a compound derived from an acid chosen among acrylic acid, methacrylic acid, maleic acid, itaconic acid and crotonic acid, (ethyl methacrylate, methyl methacrylate, butyl methacrylate, ethyl acrylate, methyl acrylate, butyl acrylate), hydroxyethylmethacrylate, hydroxyethylacrylate, hydroxypropylmethacrylate, hydroxypropylacrylate, styrene and combinations thereof. Much more preferentially according to the invention, the monomer M can be combined with at least one other non-ionic monomer M4 chosen among ethyl acrylate, methyl acrylate, butyl acrylate, styrene and combinations thereof.

Preferably according to the invention, the monomer M4 is used in an amount of from 2% by weight to 30% by weight, preferably from 5% by weight to 25% by weight or from 10% by weight to 20% by weight relative to the total amount by weight of monomers.

Preferably according to the invention, the polymer P is prepared in the absence of acrylamide monomer or of acrylamide derivative, in particular in the absence of acrylamide, of methacrylamide, of dimethacrylamide, of diethylacrylamide and of N-methylolacrylamide.

Also preferably according to the invention, the polymer P is prepared in the absence of cross-linking monomer and in the absence of halogenated monomer, in particular in the absence of fluorinated monomer.

Also preferably according to the invention, the polymer P is prepared using a combination of monomers M and M3, a combination of monomers M and M4, a combination of monomers M, M3 and M4.

More preferably according to the invention, the polymer P is prepared using a combination of monomers M1 and M3, a combination of monomers M1 and M4, a combination of monomers M1, M3 and M4.

If another monomer is used when preparing the polymer P, the proportions of monomer M and of the additional monomer can vary widely. Preferably, the amount of monomer used other than monomer M makes it possible to obtain a water-soluble copolymer P. According to the invention, the copolymer P is water-soluble. Preferably according to the invention, the water-soluble copolymer P is prepared using a majority amount by weight of anionic monomers. Advantageously, the polymer P is soluble in any amount of water at room temperature, preferably at different pH values, particularly at pH values ranging from 2 to 12. Preferably according to the invention, the polymer P can be prepared using:
from 2% by weight to 100% by weight, preferably from 2% by weight to 95% by weight, of monomer M, preferably a monomer M chosen among monomer M1, monomer M2 and combinations thereof.

More preferably according to the invention, the polymer P can be prepared using:
from 2% by weight to 100% by weight, preferably from 2% by weight to 95% by weight, of monomer M, preferably a monomer M chosen among monomer M1, monomer M2 and combinations thereof, and
from 0 to 98% by weight, preferably from 5% by weight to 98% by weight, of another monomer, different from monomer M, preferably another monomer chosen among acrylic acid, methacrylic acid, ethyl acrylate, butyl acrylate and combinations thereof.

Much more preferably according to the invention, the polymer P can be prepared using:
from 2% by weight to 100% by weight, preferably from 2% by weight to 95% by weight, of 2-acrylamido-2-methylpropane sulphonic acid and
from 0 to 98% by weight, preferably from 5% by weight to 98% by weight, of another monomer, different from monomer M, preferably of at least one other monomer chosen among acrylic acid, methacrylic acid, ethyl acrylate, butyl acrylate and combinations thereof, particularly a combination of acrylic acid or methacrylic acid with ethyl acrylate or with butyl acrylate.

Also much more preferably according to the invention, the polymer P can be prepared using:
from 2% by weight to 100% by weight, preferably from 2% by weight to 95% by weight, of styrene sulphonate and
from 0 to 98% by weight, preferably from 5% by weight to 98% by weight, of another monomer, different from monomer M, preferably of at least one other monomer chosen among acrylic acid, methacrylic acid, ethyl acrylate, butyl acrylate and combinations thereof, particularly a combination of acrylic acid or methacrylic acid with ethyl acrylate or with butyl acrylate.

During the polymerisation reaction, the use of a single monomer M, preferably a single monomer M1 or a single monomer M2, results in a homopolymer P1 according to the invention. The use of at least two different monomers M, preferably of at least two different monomers M1 or M2, or of at least one monomer M and of at least one other different monomer, preferably of at least one other monomer M3 or M4, results in a copolymer P2 according to the invention. According to the invention, the homopolymer P1 and the copolymer P2 can be used separately or be combined. Thus, the composition T according to the invention can comprise at least one binding agent L chosen among homopolymers P1, copolymers P2 and combinations thereof.

Preferably according to the invention, the polymerisation reaction is carried out at a temperature above 30° C. and below 130° C., preferably below 100° C. or below 90° C. or below 80° C. or below 75° C. Preferably during the polymerisation reaction to prepare the polymer P, the initiator compound is chosen among a peroxide (for example hydrogen peroxide), a hydroperoxide (for example tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof. Preferably according to the invention, the polymer P is prepared in a polar solvent, in particular a solvent chosen among water, alcohol, toluene, a ketone, a chlorinated solvent, an ester and combinations thereof.

Also preferably according to the invention, the polymer P can be prepared in the presence of a chain transfer agent, preferably in the presence of a compound chosen among isopropyl alcohol, mercaptan, dodecyl-mercaptan, phosphorous acid, phosphite, hypophosphorous acid, hypophosphite, bisulphite, an alkyl iodide, an alkyl bromide and combinations thereof.

According to the invention, the polymer P can be non-neutralised or it can be partially neutralised or completely neutralised. Preferably, the polymer P is non-neutralised or partially neutralised. According to the invention, the carboxyl groups of the polymer P can be partially neutralised at a rate of 70 to 97 mol %, preferably at a rate of 90 to 95 mol %. The polymer P can be partially or completely neutralised using at least one monovalent ion or at least one divalent ion. According to the invention, the polymer P can be partially or completely neutralised using a combination of at least one monovalent ion and of at least one divalent ion. According to the invention, the polymer P can thus be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30 or 50/50.

According to the invention, neutralisation can be carried out using a primary amine, a secondary amine or a monovalent ion chosen among K⁺, Na⁺, Li⁺, NH₄⁺ or an amine and combinations thereof. The preferred monovalent ion is chosen among Na⁺, Li⁺, NH₄⁺. According to the invention, neutralisation can also be carried out using a divalent ion chosen among Ca²⁺, Zn²⁺, Mg²⁺ and combinations thereof. The preferred divalent ion is Ca²⁺.

According to the invention, the polymer P can be neutralised using at least one compound chosen among NaOH, KOH, LiOH, ammonium derivatives, ammonia, ammonium hydroxide, primary amine, secondary amine, CaO, Ca(OH)₂, ZnO, Zn(OH)₂, MgO, Mg(OH)₂ and combinations thereof. Neutralising the polymer P using ammonia is particularly advantageous when using the composition T at a pH of less than 7, preferably at a pH of less than 5. According to the invention, the polymer P can be completely or partially neutralised using an amine base, for example a base chosen among ethylene diamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, triethanolamine, aminomethylpropanol or 2-amino-2-methylpropanol (AMP) and combinations thereof.

Preferably according to the invention, the pH of the polymer P is less than 12 or less than 11 or ranges from 2 to 12 or from 5 to 11. Also preferably according to the invention, the pKa of the polymer P is less than 3.5 or ranges from 1.5 to 2.5.

The polymer P has a weight-average molecular mass Mw (measured by SEC) ranging from 2,000 g/mol to 1,000,000 g/mol. Preferably, the polymer P has a weight-average molecular mass Mw (measured by SEC) of less than 800,000 g/mol, less than 500,000 g/mol, more preferentially less than 300,000 g/mol. The polymer P generally has a weight-average molecular mass Mw (measured by SEC) greater than 5,000 g/mol or greater than 15,000 g/mol, preferably greater than 50,000 g/mol or greater than 100,000 g/mol. The polymer P generally has a polymolecularity index PI (measured by SEC) of less than 4 or ranging from 1.2 to 4 or from 1.5 to 4; from 1.2 to 3 or from 1.5 to 3; from 1.2 to 2.5 or even from 1.5 to 2.5.

According to the invention, the molecular weight or mass of the polymer P is determined by Size Exclusion Chromatography (SEC). A test portion of the polymer solution corresponding to 90 mg of dry solids content is placed into a 10 mL flask. Mobile phase is added, together with 0.04% of dimethylformamide (DMF), until a total mass of 10 g is reached. The composition of this mobile phase is as follows: NaHCO₃:0.05 mol/L, NaNO₃: 0.1 mol/L, triethanolamine: 0.02 mol/L, NaN₃ 0.03% by mass. The SEC chain is composed of a Waters 510 isocratic pump with a flow rate set to 0.8 mL/min, of a Waters 717+ sample changer, of an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standards Service with a molecular weight at the top of the peak comprised between 1,000 g/mol and 1.106 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using “PSS WinGPC Scientific” software v 4.02. The chromatogram obtained is incorporated into the area corresponding to molecular weights of more than 250 g/mol.

Generally according to the invention, the binding agent L comprises the polymer P in the form of particles.

Preferably according to the invention, the binding agent L comprises from 5% by weight to 100%, preferably from 10% by weight to 70%, by weight of polymer P.

Essentially according to the invention, the aqueous composition T comprises at least one binding agent L. Advantageously, the composition T according to the invention can comprise no other binding agent. Also advantageously, the composition T according to the invention can also comprise at least one other binding agent, different from the agent L, preferably another binding agent chosen among a (meth)acrylic polymer, a comb polymer, carboxymethylcellulose (CMC), hydroxymethylcellulose, hydroxyethylcellulose, alginate, styrene-butadiene polymer, poly(allylamine, HCl), amylopectin, a copolymer of acrylic acid and of acrylonitrile and combinations thereof.

Also advantageously, the composition T according to the invention can also comprise at least one organic acid or one mineral acid, preferably an acid chosen among sulphuric acid, phosphoric acid, phosphorous acid, hypophosphorous acid, acetic acid and combinations thereof.

Essentially according to the invention, the aqueous composition T comprises at least one material E. Preferably according to the invention, the composition T comprises a material E chosen among silicon, lithium, carbon graphite or graphitic carbon, hexagonal carbon, rhombohedral carbon and combinations thereof, optionally doped with at least one element, preferably chosen among lithium, germanium, silicon and combinations thereof. The preferred material E is chosen among carbon graphite, silicon and combinations thereof.

In particular, the material E can be chosen among a conductive carbon compound, furnace black, acetylene black, Ketjen carbon black, carbon nanotubes (CNTs), synthetic graphite, natural graphite, hard carbon, activated carbon, carbon black, graphene, mesoporous carbon, amorphous silicon, semi-crystalline silicon, silicon oxides, silicon nanowires, tin, tin oxides, germanium, lithium titanate, materials suitable for use as an anode in a lithium-ion battery and combinations thereof.

According to the invention, material E can include conductive materials or materials capable of intercalating or accepting lithium ions.

Advantageously according to the invention, composition T may also include other ingredients. In particular, the composition T according to the invention can also comprise polyethylene, a fluorinated binding compound, for example a compound chosen among polyvinylidene fluoride (PVDF), poly(vinyl-pyrrolidone), polytetrafluoroethylene (PTFE), chlorotrifluoroethylene (ECTFE), polyethylene tetrafluoroethylene (ETFE), fluorinated ethylene propylene (FEP), perfluoroalkoxy (PFA), polychlorotrifluoroethylene (PCTFE), fluoracrylates, fluorosilicones and combinations thereof.

Within the composition T, the proportions of the various ingredients can vary. Preferably, the composition T according to the invention comprises:
from 1% to 15% by dry weight of binding agent L, and
from 85% to 99% by dry weight of material E,
   relative to the total amount by dry weight of binding agent L and of material E.

The invention also provides a method for preparing a composition T. The preparation method comprises:
the preparation of a binding agent L according to the invention,
the addition of at least one material E chosen among metal fibres, metal particles, carbon graphite fibres, carbon graphite particles and combinations thereof, preferably material E is chosen among silicon, lithium, carbon graphite or graphitic carbon, hexagonal carbon, rhombohedral carbon and combinations thereof, optionally doped with at least one element, preferably chosen among lithium, germanium and combinations thereof.

The invention also provides a method for producing an anode using a composition T according to the invention. The anode production method comprises:
applying at least one composition T according to the invention to a substrate,
drying and then calendering the coated substrate.

Preferably according to the invention, calendering is carried out using a press, for example at a pressure ranging from 0.1 t/cm² to 2 t/cm², preferably from 0.2 t/cm² to 1 t/cm².

Advantageously according to the invention, the substrate or current collector can be in the structural form of a plate, a film, a mesh, a foam, a sheet, a rod or any other form that does not significantly impair its ability to collect electric current. Generally, the substrate is in the form of a sheet, preferably a sheet of copper metal (Cu⁰) or a sheet of nickel metal (Ni⁰).

Preferably, the invention provides a production method according to the invention in which the application is carried out at a pH of less than 7 or at a pH ranging from 4 to 6.5. Also preferably, the invention provides a production method according to the invention in which the application of the composition T to the substrate is carried out on a metal surface to a thickness after drying and calendering that is less than 500 μm, preferably less than 100 μm or less than 50 μm. Generally according to the invention, the thickness of the composition T after application to the substrate, drying and calendering is greater than 5 μm. According to the invention, the thickness of the composition T after application to the substrate, drying and calendering is measured using a coating thickness gauge of from 1 μm to 1,000 μm, in particular from 20 μm to 30 μm. Particularly preferably, the invention provides a production method in which the application of the composition T to the substrate is uniform. According to the invention, the composition is applied uniformly when the particles of material E are evenly distributed in the layer. According to the invention, uniformity is measured by visual inspection through direct observation with the naked eye. According to the invention, the application is uniform when no aggregates are visible on the surface of the layer when viewed from the front in daylight.

Preferably when producing an anode according to the invention, at least one of the application steps is carried out at a pH of less than 7, preferably at a pH of less than 5.

The composition T according to the invention is applied by a method known as such. It can be applied by spraying, rolling, coating, heliogravure or any other means of applying an aqueous formulation to a surface.

The invention makes it possible to produce an anode using the composition T according to the invention. Thus, the invention provides an anode prepared according to the production method according to the invention.

According to the invention, the particular, advantageous or preferred characteristics of the composition T according to the invention define preparation methods, production methods and anodes according to the invention which are also particular, advantageous or preferred.

The following examples illustrate the various aspects of the invention.

### Preparation and Characterisation of a Binding Agent L Comprising the Polymer P1a According to the Invention:

50 g of a 50% by weight aqueous solution of sodium 2-acrylamido-2-methylpropane sulphonate (monomer M1b) and 850 g of deionised water are introduced into a 1 L glass reactor with mechanical stirring and oil bath heating. This is heated to 70° C. A solution comprising 0.35 g of ammonium persulphate in 10 g of deionised water is then poured in all at once. The temperature is kept at 85° C. for 120 minutes. After cooling to room temperature, the pH is adjusted to 6.0 by adding a 50% by weight aqueous sodium hydroxide solution. This results in a binding agent L according to the invention comprising the homopolymer Pla with a weight-average molecular mass, Mw, measured by SEC, of 177,000 g/mol in aqueous solution with a concentration of 12% by weight.

### Preparation and Characterisation of a Binding Agent L Comprising the Polymer P1b According to the Invention:

165 g of sodium styrene sulphonate (monomer M1a) dissolved in 310 g of deionised water are introduced into a 1 L glass reactor with mechanical stirring and oil bath heating. This is heated to 85° C. A solution comprising 0.7 g of ammonium persulphate in 10 g of deionised water is then poured in all at once. The temperature is kept at 90° C. for 90 minutes. After cooling to room temperature, the pH is adjusted to 8.5 by adding a 50% by weight aqueous sodium hydroxide solution. This results in a binding agent L according to the invention comprising the homopolymer P1b with a weight-average molecular mass, Mw, measured by SEC, of 183,500 g/mol in aqueous solution with a concentration of 25% by weight.

### Preparation and Characterisation of a Binding Agent L Comprising the Polymer P1c According to the Invention:

247 g of sodium styrene sulphonate (monomer M1a) dissolved in 464 g of deionised water are introduced into a 1 L glass reactor with mechanical stirring and oil bath heating. This is heated to 85° C. A solution comprising 2.2 g of ammonium persulphate in 16 g of deionised water is then poured in all at once. The temperature is kept at 90° C. for 90 minutes. After cooling to room temperature, the pH is adjusted to 8.5 by adding a 50% by weight aqueous sodium hydroxide solution. This results in a binding agent L according to the invention comprising the homopolymer P1c with a weight-average molecular mass, Mw, measured by SEC, of 108,000 g/mol in aqueous solution with a concentration of 33% by weight.

### Preparation and Characterisation of a Binding Agent L Comprising the Polymer P1d According to the Invention:

50 g of isopropanol and 150 g of deionised water are introduced into a 1 L glass reactor with mechanical stirring and oil bath heating. This is heated to reflux at 81° C. Then the following is poured in, in parallel, using 2 pumps, over 120 min:
a solution comprising 20 g of ammonium persulphate in 30 g of deionised water,
a solution comprising 243 g of sodium styrene sulphonate (monomer M1a) and 566 g of deionised water.

Then, the isopropanol is separated by distillation. After cooling to room temperature, deionised water is added and the pH is adjusted to 8.3 by adding a 50% by weight aqueous sodium hydroxide solution. This results in a binding agent L according to the invention comprising the homopolymer P1d with a weight-average molecular mass, Mw, measured by SEC, of 10,000 g/mol in aqueous solution with a concentration of 27% by weight.

### Preparation and Characterisation of a Binding Agent L Comprising the Polymer P2a According to the Invention:

50 g of a 50% by weight aqueous solution of sodium 2-acrylamido-2-methylpropane sulphonate (monomer M1b), 60 g of acrylic acid (monomer M3a), 15 g of ethyl acrylate (monomer M4a) and 805 g of deionised water are introduced into a 1 L glass reactor with mechanical stirring and oil bath heating. This is heated to 70° C. A solution comprising 0.35 g of ammonium persulphate in 10 g of deionised water is then poured in all at once. The temperature is kept at 85° C. for 60 minutes. Again, a solution comprising 0.35 g of ammonium persulphate in 10 g of deionised water is poured in all at once. The temperature is kept at 85° C. for 60 minutes. After cooling to room temperature, the pH is adjusted to 6.0 by adding a 50% by weight aqueous sodium hydroxide solution. This results in a binding agent L according to the invention comprising the copolymer P2a with a weight-average molecular mass, Mw, measured by SEC, of 158,000 g/mol in aqueous solution with a concentration of 11.1% by weight.

### Preparation and Characterisation of a Binding Agent L Comprising the Polymer P2b According to the Invention:

75 g of acrylic acid (monomer M3a), 25 g of sodium styrene sulphonate (monomer Mla) and 805 g of deionised water are introduced into a 1 L glass reactor with mechanical stirring and oil bath heating. This is heated to 70° C. A solution comprising 0.35 g of ammonium persulphate in 10 g of deionised water is then poured in all at once. The temperature is kept at 85° C. for 60 minutes. Again, a solution comprising 0.35 g of ammonium persulphate in 10 g of deionised water is poured in all at once. The temperature is kept at 85° C. for 60 minutes. After cooling to room temperature, the pH is adjusted to 6.3 by adding a 50% by weight aqueous sodium hydroxide solution. This results in a binding agent L according to the invention comprising the copolymer P2b with a weight-average molecular mass, Mw, measured by SEC, of 181,000 g/mol in aqueous solution with a concentration of 11.3% by weight.

### Preparation and Characterisation of a Binding Agent L Comprising the P2c Polymer According to the Invention:

25 g of sodium styrene sulphonate (monomer M1a), 60 g of acrylic acid (monomer M3a), 15 g of ethyl acrylate (monomer M4a) and 830 g of deionised water are introduced into a 1 L glass reactor with mechanical stirring and oil bath heating. This is heated to 70° C. A solution comprising 0.35 g of ammonium persulphate in 10 g of deionised water is then poured in all at once. The temperature is kept at 85° C. for 60 minutes. Again, a solution comprising 0.35 g of ammonium persulphate in 10 g of deionised water is poured in all at once. The temperature is kept at 85° C. for 60 minutes. After cooling to room temperature, the pH is adjusted to 5.8 by adding a 50% by weight aqueous sodium hydroxide solution. This results in a binding agent L according to the invention comprising the copolymer P2c with a weight-average molecular mass, Mw, measured by SEC, of 165,000 g/mol in aqueous solution with a concentration of 11.2% by weight.

### Preparation and Characterisation of a Binding Agent L Comprising the Polymer P2d According to the Invention:

300 g of deionised water are introduced into a 1 L glass reactor with mechanical stirring and oil bath heating. This is heated to 94° C. Then the following is poured in, in parallel, using 2 pumps, over 120 min:
a solution comprising 8 g of ammonium persulphate in 50 g of deionised water,
a solution comprising 206 g of acrylic acid (monomer M3a), 36.4 g of sodium styrene sulfonate (monomer M1a) and 50 g of deionised water.

The temperature is kept at 94° C. for 60 minutes. After cooling to room temperature, the pH is adjusted to 8.7 by adding a 50% by weight aqueous sodium hydroxide solution. This results in a binding agent L according to the invention comprising the copolymer P2d with a weight-average molecular mass, Mw, measured by SEC, of 26,800 g/mol in aqueous solution with a concentration of 38.5% by weight.

### Preparation of Aqueous Anode Compositions T According to the Invention

An aqueous composition comprising 5% by dry weight of polymer P2a and 5% by dry weight of carbon black (Black C65 “Imerys”) is prepared with the binding agent L comprising the polymer P2a (11.1% by weight), under stirring for 2 hours at 3,000 rpm using a stirrer fitted with a 40 mm disc wheel.

Then, 0.32 g of this aqueous composition of carbon black and of P2a polymer, 1.2 g of silicon particles (SI-100 30-50 nm, “Get Nano Materials”) and deionised water are introduced into a glass beaker, under stirring for 1 hour at 4,500 rpm using a stirrer fitted with a 25 mm disc wheel. 6.32 g of a mixture of graphites (GHDR 92.5% by weight, SFG15L 5% by weight, KS6L 2.5% by weight, “Imerys”) and deionised water are added. Stirring is continued for 1 hour. 0.4 g of styrene-butadiene binding latex (SNR BM-451B “Zeon” latex, 40% by weight) is then added and stirred for 30 min at 500 rpm. The amounts of water added are defined to obtain an aqueous anode composition T2a according to the invention with a final concentration by dry weight of 44.6%.

The aqueous anode compositions T2b to T2d according to the invention are prepared in a similar way, with a final concentration that is also 44.6% by dry weight. They respectively comprise the binding agents L according to the invention comprising the copolymers P2b to P2d.

### Production and Characterisation of Anodes According to the Invention

A 100 μm-thick copper sheet is coated with a 20 μm-thick layer of composition T1a according to the invention, using a manual application bar. Discs with a diameter of 15 mm are cut out using a precision cutter. The coated discs are calendered at 0.6 t/cm2 using a press. The discs are then dried in an oven, gradually increasing the temperature to 110° C. under vacuum for 18 hours.

After cooling to room temperature, the uniformity of the layer is assessed by visual inspection: no aggregates or surface unevenness are visible on the surface of the layer when viewed from the front in daylight.

The density of the resulting anode is then measured by weighing it on a balance, then its porosity is calculated.

Anodes are similarly prepared and characterised using the aqueous anode compositions T2b to T2d. The results are shown in Table 1.

TABLE 1

| Polymer | Density (g/cm3) | Porosity (% vol.) |
|---|---|---|
| P2a | 1.8 | 19 |
| P2b | 1.75 | 20 |
| P2c | 1.8 | 18 |
| P2d | 1.7 | 22 |

The aqueous anode compositions comprising the binding agents according to the invention therefore make it possible to prepare anodes that are stable and in which the active materials bond well to the copper layer. The anode compositions according to the invention make it possible to prepare anodes with a uniform layer. These anodes can therefore be easily used to produce rechargeable cells or secondary batteries.

### Production and Characterisation of Half-Cells Comprising Anodes According to the Invention

In a glovebox (“MBraun LabStar”) kept in an inert atmosphere (Ar, O₂ and H₂O<0.5 ppm), the electrolyte (“Solvionic” 1M, LiPF₆ in an ethylene carbonate-ethyl methyl carbonate mixture with 2% vinyl carbonate and 10% fluoro ethylene carbonate), an anode according to the invention, a pre-cut lithium disc (15.6 mm in diameter and 0.25 mm thick) then a separator disc (“Whatman” GF/C 1822-849, 17 mm in diameter, 0.26 mm thick and 1.2 μm pore size) and a separator disc (“Celgard” 2325 tri-layer PE/PP/PE) are assembled on the working electrode.

The half-cell including the anode according to the invention, prepared with the aqueous anode composition T2a, is subjected to charge-discharge cycles in a thermostatted chamber at 25° C.:
2 cycles: C/7 discharge to 0.005 V with C/100 cut-off, then C/7 charge with 1.0 V cut-off,
3 cycles: C/5 discharge to 0.005 V with C/50 cut-off, then C/5 charge with 1.0 V cut-off,
102 cycles: 1 C discharge to 0.005 V with C/40 cut-off, then 1 C charge with 1.0 V cut-off.

Half-cells including anodes according to the invention are similarly prepared and characterised with the aqueous anode compositions T2b to T2d. For each half-cell, the charge (loading), capacity, initial coulombic efficiency (ICE), coulombic efficiency after 10 cycles and then after 20 cycles (CE10, CE20), coulombic cycling efficiency—CCE1, capacity retention relative to the first cycle after 10 cycles and then after 20 cycles (CR10, CR20) are determined. The results are shown in Table 2.

TABLE 2

| | Charge | Capacity | | CE10 |
|---|---|---|---|---|
| Polymer | (mAh/cm²) | (mAh/g) | ICE (%) | cycles (%) |
| P2a | 3.05 | 743 | 88.1 | 98.80 |
| P2b | 3.15 | 774 | 88.1 | 98.78 |
| P2c | 3.06 | 754 | 88.3 | 98.82 |
| P2d | 3.15 | 771 | 87.7 | 98.70 |

| | CE20 | CCE1 | CR10 | CR20 |
|---|---|---|---|---|
| Polymer | cycles (%) | (%) | cycles (%) | cycles (%) |
| P2a | 99.01 | 74.7 | 99.62 | 99.76 |
| P2b | 98.92 | 74.6 | 99.77 | 99.80 |
| P2c | 99.02 | 76.0 | 99.68 | 99.77 |
| P2d | 98.84 | 73.8 | 99.53 | 99.67 |

The binding agents according to the invention make it possible to prepare aqueous anode compositions that are highly effective for obtaining anodes and cells with high silicon concentration and whose electrochemical properties are particularly interesting.

1. An aqueous anode composition T, comprising:
from 0.5% to 15% by dry weight of a binding agent L comprising a water-soluble polymer P, with a weight-average molecular mass Mw ranging from 2,000 g/mol to 1,000,000 g/mol, prepared in the presence of an initiator compound, by a polymerisation reaction of an organosulphur monomer M; and
from 85% to 99.5% by dry weight of a material E chosen from among metal fibres, metal particles, carbon graphite fibres, carbon graphite particles, silicon particles, and combinations thereof,
each relative to the total weight of the binding agent L and the material E.

2. The composition of claim 1, wherein the monomer M is at least one selected from the group consisting of a sulphonated monomer M1, a sulphonated monomer M2, and combinations thereof, or in which only the monomer M is used when preparing the polymer P.

3. The composition of claim 1, wherein:
the monomer M is combined with another anionic monomer M3 selected from the group consisting of acrylic acid, methacrylic acid, an acrylic acid salt, a methacrylic acid salt, maleic acid, a maleic acid salt, itaconic acid, an itaconic acid salt, crotonic acid, a crotonic acid salt, an acrylic acid oligomer, and combinations thereof, or
the monomer M is combined with another non-ionic monomer M4 selected from the group consisting of vinyl acetate, a C₁-C₈ ester from a compound derived from an acid selected from the group consisting of acrylic acid, methacrylic acid, maleic acid, itaconic acid, and crotonic acid, ethyl methacrylate, methyl methacrylate, butyl methacrylate, ethyl acrylate, methyl acrylate, butyl acrylate, hydroxyethylmethacrylate, hydroxyethylacrylate, hydroxypropylmethacrylate, hydroxypropylacrylate, an amino monomer, styrene, and combinations thereof, or
the polymer P is prepared using:
from 2% by weight to 100% by weight of monomer M, and
from 0 to 98% by weight of another monomer, different from the monomer M, or
the polymer P is prepared in the presence of at least one initiator compound selected from the group consisting of a peroxide, a hydroperoxide, a persulphate, combinations thereof and associations thereof with a metal salt, or
the polymer P is prepared in the presence of a chain transfer agent, or
the polymer P is non-neutralised, or
the pH of the polymer P is less than 12, or
the pKa of the polymer P is less than 3.5.

4. The composition of claim 1, wherein:
the polymer P has a weight-average molecular mass Mw of less than 800,000 g/mol, or
the polymer P has a weight-average molecular mass Mw greater than 5,000 g/mol.

5. The composition of claim 1, wherein the binding agent L is at least one selected from the group consisting of a homopolymer P1, a copolymer P2, and combinations thereof.

6. The composition of claim 1, further comprising an organic acid or a mineral acid.

7. The composition of claim 1, wherein the material E is silicon, lithium, carbon graphite or graphitic carbon, hexagonal carbon, rhombohedral carbon, or a combination thereof, and optionally doped with at least one element.

8. The composition of claim 1, comprising no other binding agent.

9. The composition of claim 1, further comprising polyethylene or a fluorinated binding compound.

10. The composition of claim 1, wherein:
the binding agent L is present in the composition at a dry weight of from 1% to 15%, and
the material E is present in the composition at a dry weight of from 85% to 99%,
each relative to the total weight of binding agent L and material E.

11. A method for preparing the composition of claim 1, the method comprising:
preparing the binding agent L; and
adding the material E.

12. A method for producing an anode, the method comprising:
applying the composition of claim 1 to a substrate to produce a coated substrate;
drying the coated substrate to produce a dried coated substrate; and
calendering the dried coated substrate to produce the anode.

13. The method of claim 12, wherein:
the applying is carried out at a pH of less than 7, or
the applying of the composition to the substrate is carried out to a thickness after drying and calendering that is less than 500 μm, or
the applying of the composition to the substrate is carried out to a thickness after drying and calendering that is greater than 5 μm, or
the applying of the composition to the substrate is uniform.

14. An anode, prepared according to the method of claim 12.

15. The composition of claim 1, wherein the polymer P is partially or completely neutralized.

16. The composition of claim 1, further comprising another binding agent, different from the binding agent L.
